(19) United States
(12) Patent Application Publication
(10) Pub. No.: US 2014/0203201 A1
(43) Pub. Date: Jul. 24, 2014

(54) BUTTERFLY VALVES HAVING MULTIPLE SEALS

(71) Applicant: FISHER CONTROLS INTERNATIONAL LLC, Marshalltown, IA (US)

(72) Inventor: Andrew John Kinser, Marshalltown, IA (US)

(73) Assignee: FISHER CONTROLS INTERNATIONAL LLC, Marshalltown, IA (US)

(21) Appl. No.: 13/747,057

(22) Filed: Jan. 22, 2013

(51) Int. Cl. F16K 1/226

(52) U.S. Cl. CPC F16K 1/2263
USPC 251/306

(57) ABSTRACT

Butterfly valves having multiple seals are described herein. An example butterfly valve includes a body defining a passageway between an inlet and an outlet. The example butterfly valve includes a first flexible seal coupled to a first surface of the body adjacent the inlet to engage a first portion of a disk. The example butterfly valve also includes a second flexible seal coupled to a second surface of the body adjacent to the outlet to engage a second portion of the disk different than the first portion.

### FIELD OF THE DISCLOSURE

The present disclosure relates generally to butterfly valves and, more specifically, to butterfly valves having multiple seals.

### BACKGROUND

Control valves (e.g., sliding stem valves, rotary valves, axial flow valves, globe valves, etc.) are commonly used in industrial processes, such as oil and gas pipeline distribution systems and chemical processing plants, to control the flow of process fluids. In some industrial processes, butterfly valves are used to control the flow of process fluids. Butterfly valves are favored in certain applications because they are usually inexpensive to manufacture, relatively lightweight and provide quick and tight shut off. Typically, industrial process conditions, such as pressure conditions, operation temperatures, and the type of process fluids dictate the type of valve components, including the types of butterfly valve seals that may be used.

Some known butterfly valves include a circular disk disposed within a valve body to regulate the flow of fluid through the valve. A shaft, which passes through a bore in the valve body, is coupled to the disk to rotate the disk within the valve body. It is also known that these disks move slightly within the valve body (e.g., play). In a closed position, a sealing edge on one side of the disk engages a seal to prevent the flow of fluid through the valve body. The seal (e.g., a flat metal seal) is coupled or clamped to a surface of the valve body via a seal retainer. Although effective in an application where the flow of fluid is against the sealing edge of the disk, which forces the seal against the disk, these known butterfly valves are less effective when the flow of fluid forces the seal away from the sealing edge of the disk (e.g., a reverse flow direction). In this less effective reverse flow direction, the seal is forced into the seal retainer and the disk is forced into the restricted seal, which increases the overall load on the disk and the seal. This increased load increases the torque required to rotate the disk and, thus, operate the valve.

Further, after extended use, the disk may shift or move beyond a preferred amount within the valve body due to wear of the valve components. If the disk shifts too much and is not properly aligned within the valve body, the sealing edge of the disk will not engage the seal, whether in the forward or reverse flow direction, to prevent the flow of fluid through the valve body.

### SUMMARY

In one example, an apparatus includes a body defining a passageway between an inlet and an outlet. The example apparatus includes a first flexible seal coupled to a first surface of the body adjacent the inlet to engage a first portion of a disk. The example apparatus also includes a second flexible seal coupled to a second surface of the body adjacent to the outlet to engage a second portion of the disk different than the first portion.

In another example, an apparatus described herein includes a body defining a passageway between an inlet and an outlet. The example apparatus includes a first sealing surface on a first side of a disk and a second sealing surface on a second side of the disk, the second side of the disk opposite the first side of the disk. The first sealing surface is to engage a first seal coupled to the body and the second sealing surface is to engage a second seal coupled to the body.

In yet another example, an apparatus includes means for controlling a flow of fluid through a passageway of a valve body having an inlet and an outlet. The example apparatus includes first means for sealing to prevent the flow of fluid in the passageway, the first means for sealing to seal or engage the means for controlling to prevent the flow of fluid in a first direction. The example apparatus also includes second means for sealing to prevent the flow of fluid in the passageway, the second means for sealing to seal or engage the means for controlling to prevent the flow of fluid in a second direction opposite the first direction.

### BRIEF DESCRIPTION OF THE DRAWINGS

FIG. 1A illustrates a partially sectioned front view of a known butterfly valve.

FIG. 1B illustrates a cross-sectional view of a portion of the known butterfly valve of FIG. 1A.

FIG. 1C illustrates an enlarged cross-sectional view of the portion of the known butterfly valve shown in FIG. 1B.

FIG. 2A illustrates a cross-sectional view of an example butterfly valve in a closed position in accordance with the teachings of this disclosure.

FIG. 2B illustrates an enlarged cross-sectional view of a portion of the example butterfly valve of FIG. 2A.

FIG. 3 illustrates a cross-sectional view of the example butterfly valve of FIGS. 2A and 2B in an open position.

FIG. 4 illustrates a cross-sectional view of an example butterfly valve having an alternative seal configuration.

### DETAILED DESCRIPTION

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness. Additionally, several examples have been described throughout this specification. Any features from any example may be included with, a replacement for, or otherwise combined with other features from other examples.

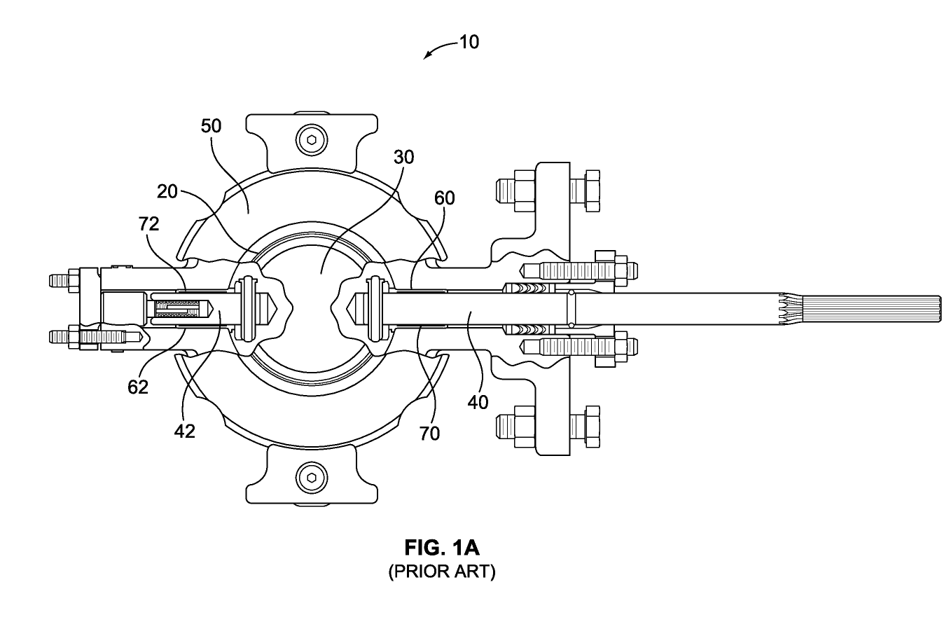

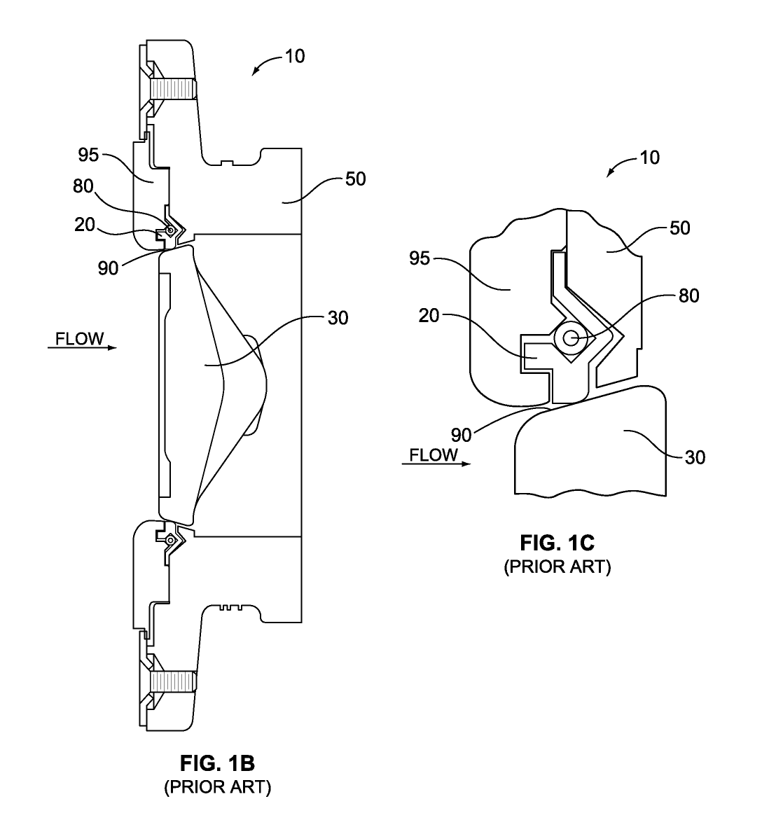

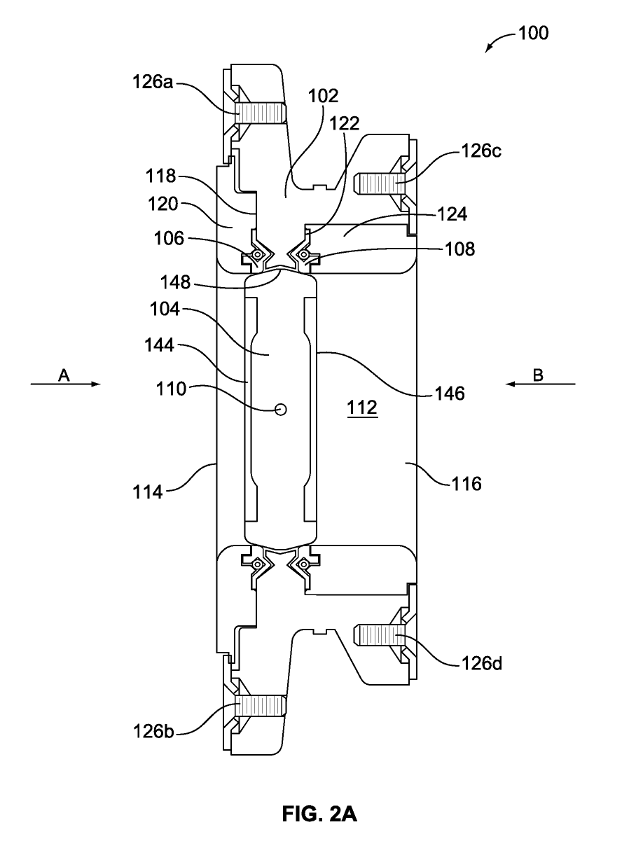

A known butterfly valve 10 is shown in FIG. 1A. The butterfly valve 10, which may be, for example, the 8580 Valve made by Fisher®, a division of Emerson Process Management of St. Louis, Mo., includes a single polytetrafluoroethylene (PTFE) seal ring 20, a disk 30 and shafts 40 and 42. The shafts 40 and 42 are attached to a backside of the disk 30 and rotate the disk 30 within a valve body 50 to allow or prevent the flow of fluid through the valve body 50. The shafts 40 and 42 are disposed in respective bores 60 and 62 in the valve body 50 and rotate via respective bearings 70 and 72. In an open position, the shafts 40 and 42 are rotated such that the disk 30 is parallel (not shown) to the flow of fluid and, thus, provides substantially unrestricted flow through the valve body 50. In a closed position (e.g., the position shown in FIG. 1A), the shafts 40 and 42 are rotated so the disk 30 blocks the passage of the valve body 50 and prevents the flow of fluid through the valve body 50.

A cross-section of the known butterfly valve 10 is shown in FIG. 1B, and an enlarged portion of the cross-section is shown in FIG. 1C. As shown in FIGS. 1A, 1B and 1C, the PTFE seal ring 20 is secured within the valve body 50. A spring 80 biases a section of the PTFE seal ring 20 radially inward (e.g., toward a center of the valve body 50). As the valve 10 is closed, the disk 30 is rotated such that a sealing edge 90 of the disk 30 slides against the PTFE seal ring 20 into the closed position. The spring 80 allows the PTFE seal ring 20 to compress as the disk 30 is rotated into position and biases the PTFE seal ring 20 radially inward to create a sufficiently tight seal between the PTFE seal ring 20 and the sealing edge 90 of the disk 30. PTFE seals, such as that depicted in FIGS. 1A, 1B and 1C, provide excellent sealing performance and a relatively long seal life.

However, these known butterfly valves are typically more effective in a forward flow direction (e.g., a preferred flow direction) than a reverse flow direction (e.g., a non-preferred flow direction). In the closed position, as shown in FIGS. 1B and 1C, pressure from the flow of process fluid in the forward flow direction (shown in the direction of the flow arrow) forces the PTFE seal ring 20 in the direction of the fluid flow and, therefore, against the sealing edge 90 of the disk 30 to create a sufficiently tight seal between the PTFE seal ring 20 and the disk 30, which prevents the leakage of process fluids around the disk 30 and through the valve body 50. However, in an opposite flow direction (e.g., the non-preferred flow direction), pressure from the process fluid can push the PTFE seal ring 20 away from the sealing edge 90 of the disk 30, against the biasing force of the spring 80, and into a seal retainer 95. The disk 32, which is known to move slightly within the valve body 50 (e.g., play), is then forced into the PTFE seal ring 20, which is restricted by the seal retainer 95 and, thus, increases the load on the PTFE seal ring 20 and the disk 30. As a result, the torque required to operate the valve is increased and increased wear of the PTFE seal ring 20 may occur. Therefore, these known butterfly valves are typically employed and/or more effective in applications involving only a single fluid flow direction (e.g., the preferred flow direction).

Also, these known butterfly valves must maintain very tight tolerances. The disk 30 is positioned such that the sealing edge 90 of the disk 30 is sufficiently close to the PTFE seal ring 20 to compress the PTFE seal ring 20 in the closed position, yet still enable the disk 30 to slide past the PTFE seal ring 20 when opening and closing the valve 10. However, after an extended period of use, the disk 30 may shift within the passage of the valve body 50 beyond a desired amount. Such shifting may occur due to cyclical forces imparted on the PTFE seal ring 20 during repeated opening and closing of the valve 10. Also, wear occurs on the bearings 70 and 72, the shafts 40 and 42 and/or the bores 60 and 62 in the valve body 50. Eventually the shafts 40 and 42 may shift within the valve body 50 and cause the disk 30 to become misaligned within the valve body 50. If the disk 30 shifts or moves within the valve body 50 beyond an allowable amount, it will not properly engage the PTFE seal ring 20 to prevent the flow of process fluid through the butterfly valve 10.

The example multiple seal butterfly valves described herein have an increased life span, provide more effective sealing (e.g., shutoff) than a single seal butterfly valve, allow for use of the valves in two flow directions, prevent excess leakage when a disk shifts due to wear, and significantly reduce maintenance costs. In general, the example butterfly valves described herein include a valve body, a disk and multiple (e.g., two) seal rings (e.g., PTFE seal rings, cantilevered metal seal rings, graphite laminated seal rings, etc.). In some examples a seal is disposed on each side of the disk when the valve is in a closed position.

In particular, an example butterfly valve described herein includes a first seal and a second seal disposed within a valve body. The second seal is coaxially aligned and spaced apart from the first seal within the valve body. In a closed position, a disk is rotated to a position such that the first seal engages a first portion (e.g., a surface, an edge, a corner) of the disk and the second seal engages a second portion of the disk opposite the first portion. The second seal advantageously keeps the disk aligned within the valve body and provides effective sealing (e.g., shutoff) when the valve is disposed within a flow path capable of subjecting the example butterfly valve to two fluid flow directions.

More specifically, the disk may be rotated to a closed position at which the first portion of the disk engages the first seal and the second portion of the disk engages the second seal. In operation, when a process fluid flows in a first direction, pressure from the process fluid forces the first seal toward the first portion of the disk and creates a sufficiently tight seal to prevent the flow of process fluid around the edges of the disk. If the flow direction is reversed, pressure from the process fluid forces the second seal toward the second portion of the disk and, likewise, creates a sufficiently tight seal to prevent the flow of process fluid around the edges of the disk.

The example butterfly valves described herein also have increased life span because the second seal provides an additional seal if the disk shifts or moves within the valve body. If the disk shifts within the valve body, due to cyclical forces and/or wear, the first seal or the second seal biases the disk (i.e., aligns the disk) to its proper location and provides a secondary or safety seal to further restrict the flow of process fluid around the disk and, thus, through the valve body.

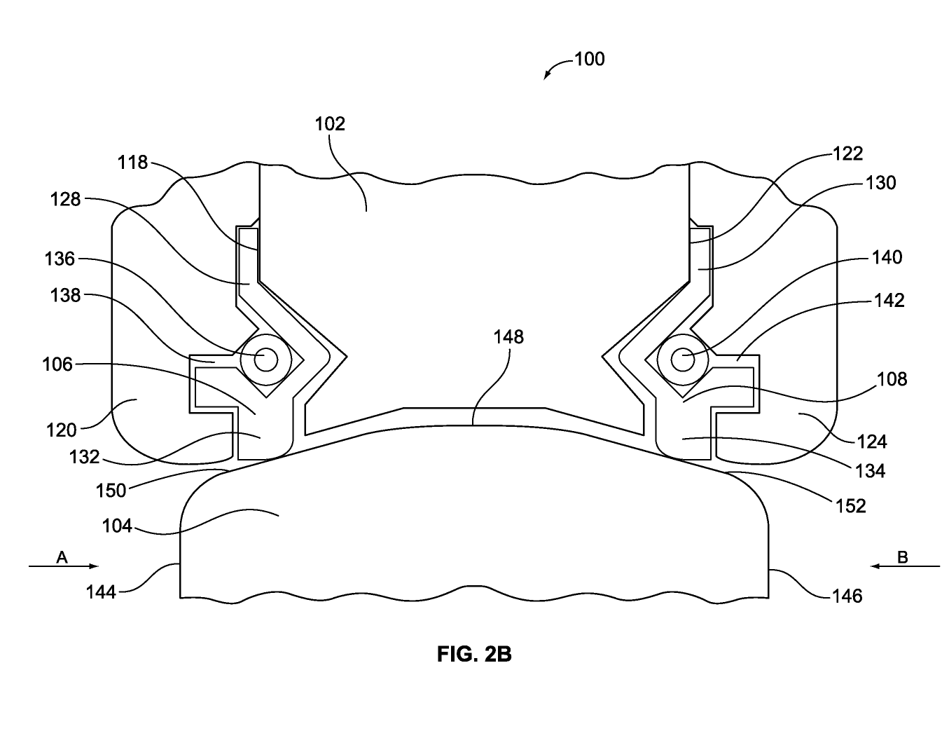

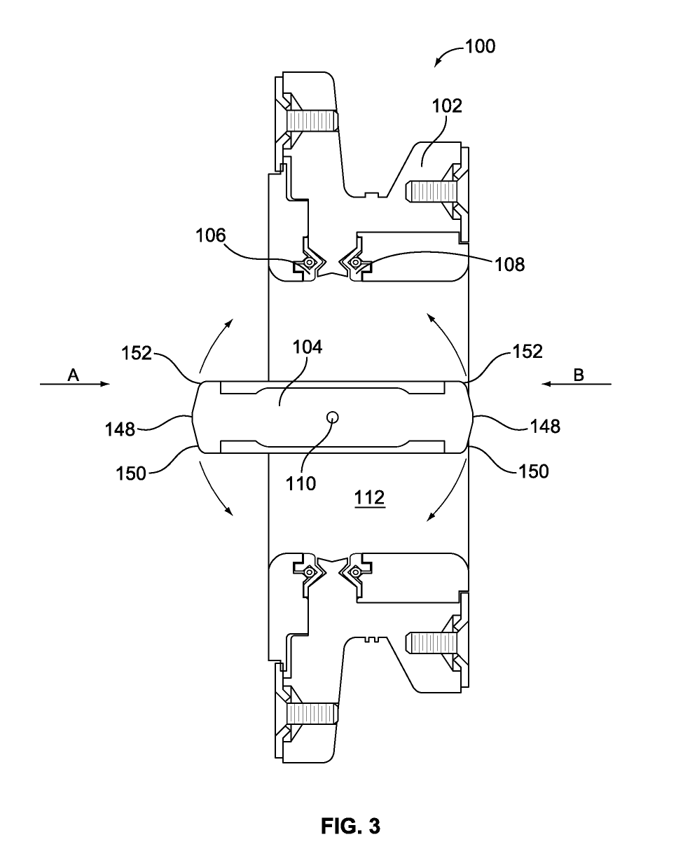

FIG. 2A is a cross-sectional view of an example butterfly valve 100 described herein. The butterfly valve 100 shown may, for example, be used to control the flow of process fluids, such as natural gas, oil, water, etc. The butterfly valve 100 includes a valve body 102, a disk 104 (e.g., a movable flow control member), a first seal 106, a second seal 108 and a shaft 110. The valve body 102 defines a passageway 112 between an inlet 114 and an outlet 116 when the butterfly valve 100 is installed in a fluid process system (e.g., a distribution piping system). In the examples described herein, the inlet 114 and the outlet 116 may either be an inlet or an outlet for the flow of process fluids through the valve 100 depending on the direction of fluid flow. As shown, the first and second seals 106 and 108 are coaxially aligned and spaced apart (e.g., separated) from each other along the fluid flow path through the valve body 102. In the example shown, the first and second seals 106 and 108 are PTFE seal rings. However, in other examples, the first and second seals 106 and 108 may be any type of seals (e.g., graphite laminated seals).

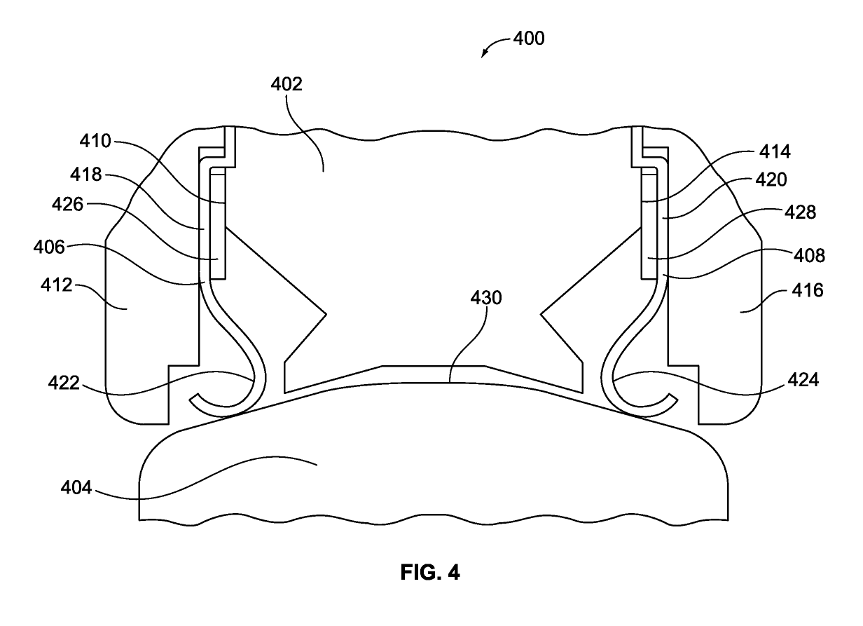

In the example shown in FIG. 2A, the butterfly valve 100 is in a closed position. The butterfly valve 100 may be interposed in a fluid flow path between an upstream supply source and a downstream supply source to control the flow of fluid therebetween. In operation, the disk 104 operates between the closed position (e.g., the position shown in FIG. 2A) to prevent the flow of fluid between the inlet 114 and the outlet 116 and an open position (e.g., the position shown in FIG. 3) to allow the flow of fluid between the inlet 114 and the outlet 116.

As shown in FIG. 2A, the disk 104 is coupled to the shaft 110, which is disposed within a bore (now shown) of the valve body 102. The shaft 110 may be rotatably coupled to valve body 102 via bearings (not shown). The bearings may be any type of bearings known to those skilled in the art to allow the shaft 110 and disk 104 to rotate within the valve body 102.

The first seal 106 is coupled to a first surface 118 of the valve body 102 by a first seal retainer 120. The second seal 108 is coupled to a second surface 122 of the valve body 102 by a second seal retainer 124. The first and second seal retainers 120 and 124 form a fluid seal between the disk 104 and the first and second seals 106 and 108. The first and second seal retainers 120 and 124 are configured to provide simplified maintenance access to the first and second seals 106 and 108 for replacement and prevent direct exposure of the first and second seals 106 and 108 to process fluid. The first seal retainer 120 and the second seal retainer 124 are removably coupled or clamped to the first and second surfaces 118 and 122 via mechanical fasteners 126a-d, such as, for example, bolts, or any other mechanical fastener(s). The example clamp design shown in FIG. 2A provides a seal between the first and second seal retainers 120 and 124, the valve body 102, and the first and second seals 106 and 108 by creating intimate contact therebetween to substantially prevent the flow of process fluid between the first and second seal retainers 120 and 124 and the valve body 102. In the example shown, the butterfly valve 100 has four mechanical fasteners 126a-d. However, in other examples, the butterfly valve 100 may have more or fewer mechanical fasteners. Additionally, gaskets (not shown) may be provided adjacent to the first and second seal retainers 120 and 124, the valve body 102 and the first and second seals 106 and 108 to improve seal performance.

An enlarged cross-sectional view of the butterfly valve 100 is illustrated in FIG. 2B. As shown, the first seal 106 and the second seal 108 include respective flange portions 128 and 130 and sealing portions 132 and 134. The first flange portion 128 of the first seal 106 is clamped or coupled between the first seal retainer 120 and the first surface 118 of the valve body 102. The second flange portion 130 of the second seal 108 is clamped or coupled between the second seal retainer 124 and the second surface 122 of the valve body 102. The first seal 106 has a first spring 136 disposed within a first cavity 138 between the first seal retainer 120 and the first surface 118 of the valve body 102. Similarly, the second seal 108 has a second spring 140 disposed within a second cavity 142 between the second seal retainer 124 and the second surface 122 of the valve body 102.

As shown in FIGS. 2A and 2B, the disk 104 has a first side 144, a second side 146, and a peripheral edge 148. As shown in FIG. 2B, the peripheral edge 148 includes a first tapered surface 150 (e.g., a first portion of the disk 104, a first sealing surface) and a second tapered surface 152 (e.g. a second portion of the disk 104, a second sealing surface). In the example shown, the first and second tapered surfaces 150 and 152 are curved and/or angled relative to the first and second sides 144 and 146 of the disk 104. However, in other examples, the first and second tapered surfaces 150 and 152 may have any shape to allow the first and second seals 106 and 108 to slide past the peripheral edge 148 of the disk 104. In some examples, the peripheral edge 148 may be a continuous (e.g., smooth) arc or curve from the first side 144 to the second side 146 of the disk 104.

In the example shown in FIG. 2A, the first seal 106 and the second seal 108 have the same diameter. However, in other examples, the first seal 106 and the second seal 108 may have different diameters. In such examples, the first and second tapered surfaces 150 and 152 may be adjusted to accommodate the different diameters of the seals.

As shown in FIGS. 2A and 2B, the first seal ring 106 sealingly engages the first tapered surface 150 and the second seal ring 108 sealingly engages the second tapered surface 152. More specifically, the first spring 136 biases the first sealing portion 132 of the first seal 106 to sealingly engage the first tapered surface 150, and the second spring 140 biases the second sealing portion 134 of the second seal 108 to sealingly engage the second tapered surface 152. The interface (e.g., contact point or surface) between the first sealing portion 132 and the first tapered surface 150 prevents the flow of process fluid in a first direction, for example, as illustrated in FIGS. 2A and 2B as arrow A. The biasing force from the first spring 136, and the pressure from the process fluid in the first flow direction A, forces the first sealing portion 132 of the first seal 106 to create a sufficiently tight seal against the first tapered surface 150 to prevent the flow of fluid around the disk 104 and through the valve body 102. On the opposite side, the interface between the second sealing portion 134 and the second tapered surface 152 prevents the flow of process fluid when the flow of fluid is in a second flow direction, opposite the first flow direction, for example, as illustrated in FIGS. 2A and 2B as arrow B. The biasing force from the second spring 140, and the pressure from the process fluid in the second flow direction B, forces the second sealing portion 134 of the second seal 108 to create a sufficiently tight seal against the second tapered surface 152 to prevent the flow of fluid around the disk 104 and through the valve body 102. Thus, the first and second seals 106 and 108 fluidly seal the valve 100 in either flow direction, A or B. The first and second seals 106 and 108 bias the disk 104 towards the other of the first or second seal 106 or 108 such that if the disk 104 moves or within the valve body 102, the seals 106 and 108 bias the disk 104 back into its proper aligned position.

In operation, the disk 104 rotates between the closed position (e.g., the position shown in FIG. 2A) to prevent the flow of fluid through the passageway 112 between the inlet 114 and the outlet 116 (e.g., the flow direction A) or between the outlet 116 and the inlet 114 (e.g., the flow direction B) and the open position (e.g., the position shown in FIG. 3) to allow the flow of fluid through the passageway 112 of the valve body 102. To control the flow of process fluid through the valve 100, a control valve instrument (not shown) may be operatively coupled to the valve 100 and generally provides a pneumatic signal to a valve actuator (not shown) in response to a control signal from a process controller, which may be part of a distributed control system (neither of which are shown). The valve actuator may be coupled to the shaft 110, such that the pneumatic signal moves the valve actuator which, in turn, rotates the shaft 110.

As shown in FIG. 3, the disk 104 has been rotated to a position that is parallel to the flow of fluid (e.g., the flow direction A or the flow direction B) through the passageway 112 of valve body 102. To close the butterfly valve 100 to prevent or restrict the flow of fluid through the valve body 102, the shaft 110 rotates the disk either clockwise or counterclockwise (shown by the arrows). For example, the disk 104 may be rotated clockwise and, as the disk 104 approaches the closed position, a portion of the first tapered surface 150 of the disk 104 engages the second seal 108 and a portion of the second tapered surface 152 of the disk 104 engages the first seal 106. The first seal 106 and the second seal 108 flex, expand radially and then retract via the springs as the peripheral edge 148 of the disk 104 slides past the first seal 106 and the second seal 108 into the closed position. Once the disk 104 is rotated into the closed position, as shown in FIGS. 2A and 2B, the disk 104 is perpendicular to the flow of fluid and the first seal 106 sealingly engages the first tapered surface 150 and the second seal 108 sealingly engages the second tapered surface 152 to prevent the flow of fluid in either flow direction, A or B.

The example butterfly valve 100, as shown and described above, also prevents leakage of process fluid around the disk 104 if the disk 104 shifts within the valve body 102. As mentioned above, after extended use, the shaft 110, the bore (not shown) and the bearings (not shown) tend to wear due to friction and cyclical forces from opening and closing the valve 100. In the event the disk 104 shifts or moves within the valve body 102, such that one of the first seal 106 or the second seal 108 would not sealingly engage the first tapered surface 150 or second tapered surface 152, the other of the first seal 106 or the second seal 108 can provide an additional seal (e.g., a safety seal or secondary, redundant seal) and bias the disk into its proper aligned position to prevent the flow of fluid around the disk 104 and through the valve body 102.

FIG. 4 shows an enlarged cross-sectional view of an example butterfly valve 400 with an alternative type of seal. The butterfly valve 400 operates in a substantially similar manner to the valve 100 described above. The butterfly valve 400 includes a valve body 402, a disk 404, a first cantilever seal 406 and a second cantilever seal 408. The first cantilever seal 406 is coupled to a first surface 410 of the valve body 402 by a first seal retainer 412. The second cantilever seal 408 is coupled to a second surface 414 of the valve body 402 by a second seal retainer 416. The first and second cantilever seals 406 and 408 have respective flange portions 418 and 420 and curved sealing portions 422 and 424. The example butterfly valve 400 also includes gaskets 426 and 428 disposed between the first cantilever seal 406 and the first surface 410 and between the second cantilever seal 408 and the second surface 414, respectively.

The curved profile of the first and second cantilever seals 406 and 408 provides flexibility. The first and second cantilever seals 406 and 408 may, for example, be made of metal or any other material having characteristics to impart flexibility. In the example shown, the disk 404 has an edge 430 having a smooth arc-shaped profile. As the disk 404 is rotated into a closed position (e.g., the position shown), the first and second cantilever seals 406 and 408 flex as the edge 430 of the disk 404 slides past the first and second curved sealing portions 422 and 424. Similar to the butterfly valve 100 described above, the butterfly valve 400 provides effective sealing in either fluid flow direction.

In the example butterfly valve 100, both seals 106 and 108 are PTFE seals, and in the example butterfly valve 400, both seals 406 and 408 are cantilever seals. In other examples, one seal may be a PTFE seal ring and the other seal may be a cantilever type seal ring. However, the example butterfly valves described herein are operable with any type of seal ring.

The example butterfly valves 100 and 400 described herein advantageously allow for effective use of the valves in two flow directions. The addition and location of the second seal provides more effective sealing than a single seal butterfly valve in the second flow direction and assists in maintaining proper disk alignment. The example butterfly valves 100 and 400 also prevent excess leakage when a disk shifts due to wear and, therefore, increases the lifespan of the butterfly valve. With increased lifespan, the example valves also significantly reduce maintenance costs.

Although certain example apparatus have been described herein, the scope of coverage of this patent is not limited thereto. On the contrary, this patent covers all methods, apparatus, and articles of manufacture fairly falling within the scope of the appended claims either literally or under the doctrine of equivalents.

1. An apparatus comprising:
a body defining a passageway between an inlet and an outlet;
a disk disposed in the passageway to operate between a closed position and an open position, the disk having first sealing surface on a first side of the disk and a second sealing surface on a second side of the disk opposite the first side of the disk;
a first flexible seal coupled to a first surface of the body adjacent the inlet, the first flexible seal comprising a first flange and a first sealing section, the first flange coupled to the first surface of the body and the first sealing section disposed radially inward toward a center of the passageway, the first sealing section defining a first concave profile facing toward the inlet, the first sealing section to be flexed toward the first sealing surface on the first side of the disk when a flow of fluid is in a first direction and the disk is in the closed position; and
a second flexible seal coupled to a second surface of the body adjacent the outlet, the second flexible seal comprising a second flange and a second sealing section, the second flange coupled to the second surface of the body and the second sealing section disposed radially inward toward the center the passageway, the second sealing section defining a second concave profile facing toward the outlet, the second sealing section to be flexed toward the second sealing surface on the second side of the disk when a flow of fluid is in a second direction and the disk is in the closed position.

2. The apparatus as defined in claim 1, wherein the first flexible seal provides a seal against the first sealing surface of the disk when a flow of fluid through the passageway is in the first direction.

3. The apparatus as defined in claim 2, wherein the second flexible seal provides a seal against the second sealing surface of the disk when the flow of fluid through the passageway is in the second direction, the second direction opposite the first direction.

4. The apparatus as defined in claim 1, wherein the first sealing surface of the disk engages the first flexible seal and the second sealing surface of the disk engages the second flexible seal when the disk is in the closed position.

5. The apparatus as defined in claim 1, wherein the first flexible seal and the second flexible seal are coaxially aligned.

6. The apparatus as defined in claim 1, wherein at least one of the first flexible seal or the second flexible seal comprises metal.

7. The apparatus as defined in claim 1, wherein at least one of the first flexible seal or the second flexible seal is a cantilever seal.

8. The apparatus as defined in claim 1, wherein the disk is rotatably coupled to the body via a shaft.

9. The apparatus as defined in claim 1, wherein the first flexible seal and the second flexible seal have the same diameter.

10. The apparatus as defined in claim 1, wherein the first flange of the first flexible seal is coupled to the body via a first seal retainer and the second flange of the second flexible seal is coupled to the body via a second seal retainer.

11. The apparatus as defined in claim 1, wherein each of the first flexible seal and the second flexible seal comprises a respective spring.

12. The apparatus as defined in claim 1, wherein the first sealing surface of the disk includes a first tapered profile.

13. The apparatus as defined in claim 12, wherein the second sealing surface of the disk includes a second tapered profile.

14. An apparatus comprising:
a body defining a passageway between an inlet and an outlet;
a disk disposed in the passageway to operate between a closed position and an open position, the disk comprising:
a first tapered edge on a first side of the disk, the first tapered edge tapering toward a central axis of the passageway at a first angle; and
a second tapered edge on a second side of the disk, the second side of the disk opposite the first side of the disk, the second tapered edge tapering toward the central axis of the passageway at a second angle different than the first angle;
a first seal coupled to a first surface of the body adjacent the inlet, the first seal having a first concave profile facing the inlet, the first seal to be flexed toward the first tapered edge when a flow of fluid is from the inlet toward the outlet; and
a second seal coupled to a second surface of the body adjacent the outlet, the second seal having a second concave profile facing the outlet, the second seal to be flexed toward the second tapered edge when a flow of fluid is from the outlet toward the inlet.

15. The apparatus as defined in claim 14, wherein the first seal is disposed in the passageway of the body to be offset from the second seal.

16. The apparatus as defined in claim 14, wherein the first tapered edge of the disk engages the first seal and the second tapered edge of the disk engages the second seal when the disk is in the closed position.

17. The apparatus as defined in claim 14, wherein the disk is rotatably coupled to the body via a shaft.

18. An apparatus comprising:
a body defining a passageway between an inlet and a outlet;
means for controlling a flow of fluid through the passageway, the means for controlling having a first sealing surface on a first side of the means for controlling and a second sealing surface on a second side of the means for controlling opposite the first side;
first means for sealing to prevent the flow of fluid in the passageway, the first means for sealing coupled a first surface of the body adjacent the inlet, the first means for sealing comprising a first flange and a first sealing section, the first flange coupled to the first surface of the body and the first sealing section disposed radially inward toward a center of the passageway, the first sealing section defining a first concave profile facing toward the inlet, the first sealing section to be flexed toward the first sealing surface on the first side of the means for controlling when the flow of fluid is in a first direction from the inlet toward the outlet and the means for controlling is in a closed position; and
second means for sealing to prevent the flow of fluid in the passageway, the second means for sealing coupled to a second surface of the body adjacent the outlet, the second means for sealing comprising a second flange and a second sealing section, the second flange coupled to the second surface of the body and the second sealing section disposed radially inward toward the center of the passageway, the second sealing section defining a second concave profile facing toward the outlet, the second sealing section to be flexed toward the second sealing surface on the second side of the means for controlling when the flow of fluid is in a second direction opposite the first direction and the means for controlling is in the closed position.

19. The apparatus as defined in claim 18, wherein the first means for sealing is to prevent the flow of fluid in the passageway when a pressure at the inlet is greater than a pressure at the outlet.

20. The apparatus as defined in claim 18, wherein the second means for sealing is to prevent the flow of fluid in the passageway when a pressure at the outlet is greater than a pressure at in the inlet.

21. The apparatus as defined in claim 10, wherein the first flange of the first flexible seal is fixedly clamped between the first retainer and the first surface of the body and the second flange of the second flexible seal is fixedly clamped between the second retainer and the second surface of the body.

22. The apparatus as defined in claim 13, wherein the first tapered profile is at a first angle relative to a longitudinal axis of the passageway and the second tapered profile is at a second angle relative to the longitudinal axis of the passageway, the second angle substantially equal to and opposite to the first angle.

23. The apparatus as defined in claim 1, wherein a peripheral edge of the disk has a continuous or smooth profile between the first side and the second side of the disk.

24. The apparatus as defined in claim 1, wherein the first and second concave profiles are substantially the same.

25. The apparatus as defined in claim 1, wherein the first flexible seal biases the disk in the first direction and the second flexible seal biases the disk in the second direction when the disk is in the closed position.

26. The apparatus as defined in claim 1, wherein the first flexible seal biases the disk toward the second flexible seal and the second flexible seal biases the disk toward the first flexible seal.

27. The apparatus as defined in claim 1, wherein the first flexible seal is to be flexed in the first direction when a flow of fluid is in the first direction.

28. The apparatus as defined in claim 27, wherein the second flexible seal is to be flexed in the second direction when the flow of fluid is in the second direction.

29. The apparatus as defined in claim 1, wherein the flow of fluid is in the first direction when the flow of fluid is from the inlet toward the outlet and the flow of fluid is in the second direction when the flow of fluid is from the outlet toward the inlet.
